(19) United States
(12) Patent Application Publication
(10) Pub. No.: US 2017/0286902 A1
(43) Pub. Date: Oct. 5, 2017

(54) INFORMATION PRESENTATION METHOD, APPARATUS, AND SYSTEM BASED ON ELECTRONIC WAYBILL

(71) Applicant: ALIBABA GROUP HOLDING LIMITED, GRAND CAYMAN (KY)

(72) Inventor: JIE LIU, HANGZHOU (CN)

(21) Appl. No.: 15/473,315

(22) Filed: Mar. 29, 2017

(30) Foreign Application Priority Data
Mar. 31, 2016 (CN) 201610200995.5

(51) Int. Cl. G06Q 10/08; G06Q 30/06

(52) U.S. Cl. CPC G06Q 10/087; G06Q 30/0633

(57) ABSTRACT

An information presentation method includes: obtaining attribute information of order information according to the order information, based on information of at least one of a receiver or a provider in the attribute information, filtering out, in a preset information system, presentation information corresponding to at least one of the receiver or the provider, and displaying the presentation information on an electronic waybill.

### CROSS REFERENCE TO RELATED APPLICATION

The present application is based on and claims the benefit of priority to Chinese Application No. 201610200995.5, filed on Mar. 31, 2016, the entire contents of which are incorporated herein by reference.

### BACKGROUND

### Technical Field

The present application relates to the technical field of electronic waybills, and in particular, to an information presentation method and apparatus based on an electronic waybill. In addition, the present application further relates to an information presentation system based on an electronic waybill.

### Related Art

In a big-data era, promotion and application of data and information on the Internet are especially important. In the Internet environment, information promotion is often carried out by using networks. For example, accurate advertising can be realized by using data and behaviors on networks, but offline promotion of the information is limited to some extent.

For example, in the field of e-commerce industry, accurate online advertising can be achieved according to big data of behaviors of users on the Internet, but promotion of related information cannot be implemented by using offline electronic waybills. Therefore, for information that can be presented on an electronic waybill, an effective method for offline promotion and presentation of information is desired.

### SUMMARY

The present application provides an information presentation method for displaying information on an electronic waybill, to address the foregoing problems existing in the prior art. The present application further provides an information presentation apparatus and system for displaying information on an electronic waybill.

According to some embodiments of the present application, the information presentation method for displaying information on an electronic waybill comprises obtaining attribute information of order information according to the order information, filtering out, in a preset information system, based on characteristic information of at least one of an order receiver or an order provider in the attribute information, presentation information corresponding to at least one of the order receiver or the order provider, wherein the presentation information is related to the attribute information, and displaying the presentation information on an electronic waybill.

In some embodiments, the method may further include obtaining a waybill number of the order information according to the order information, and displaying the waybill number on the electronic waybill. The presentation information and the waybill number may be displayed on the electronic waybill in an electronic waybill printing manner. The method may further include printing the electronic waybill.

In some embodiments, the filtering out, in a preset information system based on characteristic information of at least one of an order receiver or an order provider in the attribute information, presentation information corresponding to at least one of the order receiver or the order provider includes: filtering out, in the preset information system, two or more pieces of candidate information corresponding to the attribute information, ranking the two or more pieces of candidate information in a preset priority ranking manner, and using candidate information ranking high as the presentation information.

The attribute information may include one or more pieces of the following information: order source information, provider attribute information, receiver attribute information, product category information, receiver address information, or provider address information.

The obtaining attribute information of order information according to the order information may include: receiving the order information from an order system, and obtaining the attribute information from an order platform according to the order information.

The presentation information includes a combination of one or more pieces of the following information: channel presentation information, provider presentation information, receiver presentation information, product category presentation information, industrial chain presentation information, or receiver location presentation information.

The filtering out, in a preset information system based on characteristic information of at least one of an order receiver or an order provider in the attribute information, presentation information corresponding to the order receiver or the order provider may include: determining whether candidate information corresponding to at least one of the order receiver or the order provider in the attribute information exists in the preset information system, if yes, ranking corresponding candidate information in a preset manner, and obtaining information ranking high in the candidate information as the presentation information.

The preset manner may include one or more of the following manners: a preset priority ranking manner, a preset stochastic ranking manner, a preset weight selection manner, or a preset time-based selection manner. In one embodiment, the preset manner is the preset time-based selection manner, and the time-based selection manner is a season-based selection manner.

In one embodiment, the presentation information is channel presentation information, and the channel presentation information includes order and channel presentation information. In another embodiment, the presentation information is provider presentation information, and the provider presentation information includes provider-related presentation information that can be presented. In a further embodiment, the presentation information is receiver presentation information, and the receiver presentation information includes receiver-related presentation information that can be presented. The receiver-related presentation information that can be presented includes one or more pieces of the following information: information on selection or browsing of products by the receiver, information on browsing on a related platform by the receiver, or information on basic information of the receiver. In a further embodiment, the presentation information is product category presentation information, and the product category presentation information includes information on products of corresponding categories or of similar categories, where products are categorized according to types and categories of the products. In yet another embodiment, the presentation information is industrial chain presentation information, and the industrial chain presentation information includes information corresponding to upstream or downstream of an industrial chain. In a further embodiment, the presentation information is receiver location presentation information, and the receiver location presentation information includes an address of a location at which the receiver is located and information on a geographical region corresponding to the address.

According to some embodiments, the displaying the presentation information on an electronic waybill includes: displaying the presentation information on the electronic waybill in a preset information display manner. The preset information display manner may include a combination of one or more of the following manners: a two-dimensional code display manner, an icon display manner, an indicative picture display manner, or a bar code display manner.

The present application further provides an information presentation apparatus based on an electronic waybill, including: an attribute information obtaining unit, configured to obtain attribute information of order information according to the order information, a presentation information obtaining unit, configured to filter out, in a preset information system based on characteristic information of at least one of an order receiver or an order provider in the attribute information, presentation information corresponding to the order receiver or the order provider, where the presentation information is information logically related to the attribute information, and a presentation information display unit, configured to display the presentation information on an electronic waybill.

In some embodiments, the apparatus may further include a waybill number obtaining unit, configured to obtain a waybill number of the order information according to the order information before or after the step of obtaining attribute information of order information according to the order information, and a waybill number display unit, configured to display the waybill number on the electronic waybill before or after the step of displaying the presentation information on an electronic waybill. The apparatus may further include an electronic waybill printing unit, configured to display the presentation information and the waybill number on the electronic waybill in an electronic waybill printing manner.

According to some embodiments, the presentation information obtaining unit includes a candidate information screening sub-unit, configured to filter out, in the preset information system, multiple pieces of candidate information corresponding to the attribute information, a ranking sub-unit, configured to rank the multiple pieces of candidate information in a preset priority ranking manner, and a presentation information forming sub-unit, configured to use candidate information ranking high as the presentation information.

The attribute information obtaining unit may include an order information receiving sub-unit, configured to receive the order information sent by an order system, and an attribute information forming sub-unit, configured to obtain the attribute information from an order platform according to the order information.

The presentation information obtaining unit may further include a determining sub-unit, configured to: determine whether candidate information corresponding to at least one of the order receiver or the order provider in the attribute information exists in the preset information system, if yes, rank corresponding candidate information in a preset manner, and a presentation information forming sub-unit, configured to obtain information ranking high in the candidate information as the presentation information.

The electronic waybill information forming unit may include a presentation information presentation sub-unit, configured to display the presentation information on the electronic waybill in a preset information display manner.

The present application further provides an information presentation system based on an electronic waybill, including an electronic waybill server, an advertisement system, and an e-commerce order system, where the e-commerce order system is used to provide order information for the electronic waybill server, the electronic waybill server obtains attribute information of order information according to the order information provided by the e-commerce order system, the electronic waybill server filters out, in the advertisement system based on characteristic information of at least one of an order receiver or an order provider in the attribute information, presentation information corresponding to the order receiver or the order provider, and the electronic waybill server outputs the presentation information to the e-commerce order system, and displays the presentation information on an electronic waybill in the e-commerce order system, where the presentation information is related to content of the attribute information.

The apparatus may further include an electronic waybill printing component and a printer, where the presentation information is displayed on the electronic waybill by using the electronic waybill printing component and the printer.

According to another aspect, the present application provides an information presentation method based on an electronic waybill, including: obtaining attribute information of order information according to the order information, filtering out, in a preset information system based on information of at least one of a receiver or a provider in the attribute information, presentation information corresponding to the receiver or the provider, where the presentation information includes information corresponding to attribute information, and displaying the presentation information on an electronic waybill. The presentation information obtained in the method is information related to at least one of a provider or a receiver. Moreover, according to the method, by using an electronic waybill that is a combination of online and offline, presentation information is promoted offline in a manner of being obtained online and delivered offline. Therefore, online promotion information can be promoted and presented offline by using an electronic waybill.

### BRIEF DESCRIPTION OF THE DRAWINGS

FIG. 1 is a flowchart of an information presentation method based on an electronic waybill according to one embodiment of the present application;

FIG. 2 is a schematic diagram of objects presented on an electronic waybill according to one embodiment of the present application;

FIG. 3 is a system diagram of an application scenario of the information presentation method based on an electronic waybill according to one embodiment of the present application;

FIG. 4 is a schematic structural diagram of an information presentation apparatus based on an electronic waybill according to another embodiment of the present application;

FIG. 5 is a schematic structural diagram of an information presentation system based on an electronic waybill according to another embodiment of the present application;

FIG. 6 is a schematic structural diagram showing additional components of an information presentation system based on an electronic waybill according to a further embodiment of the present application;

FIG. 7 is a schematic structural diagram of an attribute information obtaining unit according to one embodiment of the present application;

FIG. 8 is a schematic structural diagram of a presentation information obtaining unit according to one embodiment of the present application; and

FIG. 9 is a schematic structural diagram of a presentation information obtaining unit according to another embodiment of the present application.

### DETAILED DESCRIPTION

The present application provides an information presentation method and system based on an electronic waybill. The method can be applied to the application scenario of an electronic waybill in the logistics industry. In the logistics industry, electronic waybills have the advantage of more accurate waybill information compared with conventional waybills. Moreover, reading of waybill information on an electronic waybill is more convenient, which ensures that both a receiving user and a sending user can quickly obtain the waybill information. Therefore, in the logistics industry nowadays, more and more shipping companies use electronic waybills to replace conventional waybills.

Based on the foregoing development trend of electronic waybills, in most cases, information presented on an electronic waybill may be extended, so that the electronic waybill can function as a medium, conveying and communicating more information, and making it convenient for more people to obtain more useful information from the electronic waybill.

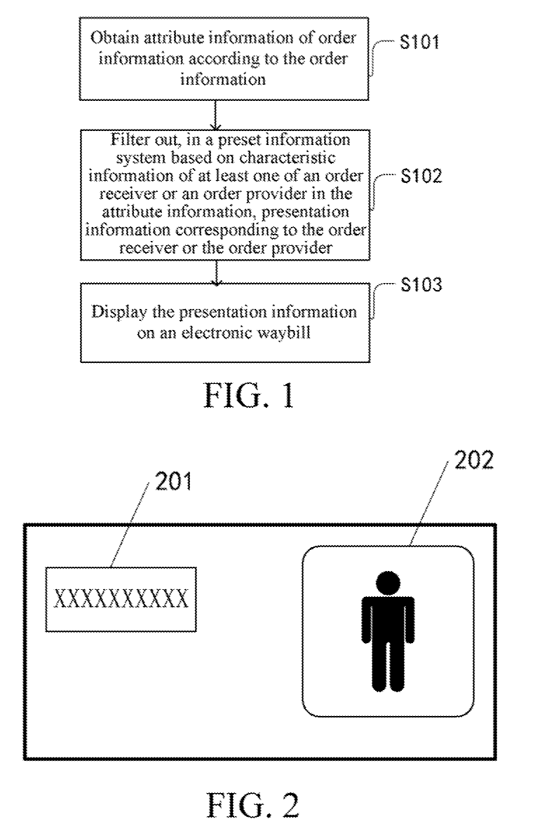

FIG. 1 is a flowchart of an information displaying/presentation method based on an electronic waybill according to a first embodiment of the present application. Referring to FIG. 1, the information presentation method includes the following steps.

S101: Obtain attribute information of order information according to the order information. The attribute information may include one or more pieces of the following information: order source information, provider attribute information, receiver attribute information, product category information, receiver address information, or provider address information.

The foregoing listing of the attribute information is a list of limited attribute characteristics, and the listed attribute information is also relatively important attributes corresponding to the order information. Each type of attribute information is described in detail below.

The order source information is information closely related to the order, where each order has a corresponding source. For example, if an order is placed on Taobao™, order source information of the order is source information related to Taobao™. Alternatively, the order source information may be from websites and platforms of some other e-commerce vendors. For example, if an order is placed on a corresponding website of an e-commerce vendor, attribute information of the order may include information related to the website and/or the e-commerce vendor.

The provider provides a product for the receiver. The provider attribute information includes a website for a product provided by the provider, creditworthiness of a shop provided by the provider, an address of the provider, and the like. Alternatively, the provider attribute information may also include a category to which a product provided by the provider belongs, and the like. In summary, any information related to the provider can be covered by the provider attribute information.

The receiver receives a product provided by the provider and thus the receiver in the receiver attribute information has a corresponding relationship with the foregoing provider. The receiver attribute information may include basic personal information (basic information such as age, height, weight, occupation, and/or education) of the receiver, and may further include habits of types of websites or e-commerce vendors browsed by the receiver, price preferences of product purchase of the receiver, and social circle information (such as information on a circle of friends, economic strengths and purchase capabilities of friends in the circle of friends) related to the receiver. In summary, any information related to the receiver can be covered by the receiver attribute information.

The product category information is a category to which a product in this order belongs, where the category may be a general broad category, or may be a specific narrow category, or may be a category related to the product in the order, which involve corresponding product categories in midstream or upstream of an industrial chain or a downstream industrial chain. For example, when a purchased product is a mobile phone, a product related to a corresponding downstream industrial chain may be a mobile phone accessory (such as a mobile phone case or a mobile phone membrane); therefore, content included in the product category information is relatively abundant.

The receiver address information is information of a location in which the receiver is located. The receiver address information may also be included in the receiver attribute information. In some embodiments, to obtain the receiver address information, it is needed to some extent to divide and manage a geographical region corresponding to the address. Therefore, the receiver address information may be considered as separate attribute information.

The provider address information and the receiver address information have similar characteristics and functions, where the provider address information is information of a location in which the provider is located, and may provide a basis for considering a transportation cost and transportation time of the product by the receiver.

The attribute information of the order information is described above, and the attribute information may be obtained in the following manners.

The obtaining attribute information of order information according to the order information may include the following steps:

Step 1: Receive the order information sent by an order system.

The electronic waybill system may receive the order information sent by the order system, where indicative information in the order information may include serial number information of a transaction of the order. In some embodiments, the serial number information may be considered as part of the order information received by the electronic waybill system.

Step 2: Obtain the attribute information from the order platform according to the order information.

On an order platform, information related to the order may be found according to the transaction serial number information in the order information, where a transaction corresponding to the transaction serial number information may indicate information of two parties in the transaction of the order, for example, receiver attribute information, provider attribute information, receiver address information, provider address information, and the like, and may also indicate a product in the order information, a category to which the product belongs, and the like. In addition, an e-commerce platform on which the transaction occurs, that is, source information of the order, may also be obtained according to the transaction serial number information.

The above has described the attribute information types and methods for obtaining the attribute information. According to the foregoing description, it may be also known that, in some embodiments, all information in the attribute information is information related to one of the receiver or the provider or both parties, for example, receiver address information or provider address information.

In addition, besides the foregoing information that may be displayed on an electronic waybill, generally, it is also needed to display an identification number indicating uniqueness of the electronic waybill on the electronic waybill, where the identification number is generally implemented by using a waybill number.

Before or after the step of obtaining attribute information of order information according to the order information, the following step may be performed:

obtaining a waybill number of the order information according to the order information.

More particularly, the order information in this step may include a transaction serial number of an order that is obtained by a user in a transaction process and basic information such as a transaction time of the order. In the step of obtaining a waybill number of the order information according to the order information, a transaction serial number in the order information is mostly used.

For a transaction serial number generated in each transaction of the user, each serial number corresponds to an effective transaction, and in the logistics industry, for each transaction, a transaction serial number corresponds to a waybill number used in the logistics industry.

The waybill number of the order may be uniquely determined according to the order information. For ease of understanding, the waybill number may be understood as a common express waybill number. Therefore, each piece of order information may correspond to a waybill number. A receiver of the order may query a status and location, at any moment after shipping, of the order according to the waybill number of the order.

The above has described embodiments for determining the waybill number. In the logistics and e-commerce industries, the method may be performed by using a corresponding operation system. Specifically, operations of the method may be performed on an e-commerce order system. The e-commerce order system is generally a system developed by an independent software vendor (ISV), and may be software that is developed for the e-commerce field based on the Alibaba™ open platform, where the e-commerce order system may provide merchants with various corresponding services such as order management, inventory management, and order-printing and goods delivery.

After corresponding operations such as order management or goods delivery in the e-commerce order system, the order information may be uploaded to the electronic waybill system, and the waybill number corresponding to the order information may be obtained by using the electronic waybill system.

S102: Filter out, in a preset information system, based on characteristic information of at least one of an order receiver or an order provider in the attribute information, presentation information corresponding to the order receiver or the order provider, where the presentation information is information logically related to content of the attribute information.

The preset information system may be understood as a platform or system for collecting presentation information. The preset information system may include the following information: order provider information that needs to be presented, presentation information of a product category involved in an order, information of a geographical region corresponding to a receiver address that needs to be presented, presentation information of purchase habits of the order receiver on an e-commerce platform, and presentation information related to information on other network platforms associated with receiver personal information.

Therefore, it can be known from the preset information system that, related presentation information in the preset information system is also characteristic information related to either one of an order receiver or an order provider or both the order receiver and the order provider, where the characteristic information is used to represent some basic characteristic information related to the order receiver or the order provider. For example, the characteristic information may be information such as an address of the order receiver. Therefore, information in the preset information system may correspond to information in the foregoing obtained attribute information. Moreover, presentation information corresponding to or related to corresponding information in the attribute information may be filtered out in the preset information system.

In some embodiments, presentation information logically related to content of corresponding attribute information that is filtered out according to the attribute information may include one or more pieces of the following information: channel presentation information, provider presentation information, receiver presentation information, product category presentation information, industrial chain presentation information, and/or receiver location presentation information.

Types of the foregoing presentation information may have basic corresponding relationships with the attribute information in the order information. The basic corresponding relationships may include: the order source information corresponds to the channel presentation information in the presentation information, the provider attribute information corresponds to the provider presentation information in the presentation information, the receiver attribute information corresponds to the receiver presentation information in the presentation information, the receiver address information corresponds to the receiver location presentation information in the presentation information, and the product category information corresponds to the product category presentation information in the presentation information, where the product category presentation information may be further divided into industrial chain presentation information, and the industrial chain presentation information corresponds to category information of products in midstream or upstream of an industrial chain or a downstream industrial chain that are related to the product category presentation information.

Types of the presentation information are described above, and a manner of obtaining the presentation information is described below. Specifically, the filtering out, according to the attribute information, presentation information corresponding to corresponding attribute information includes:

filtering out, in the preset information system, multiple pieces of candidate information corresponding to information of at least one party in the attribute information.

This step filters out candidate information in the preset information system, where all the candidate information may be considered as presentation information, but only candidate information having undergone priority ranking may be presented as presentation information.

For example, receiver presentation information that corresponds to receiver attribute information and that is filtered out in the preset information system according to the receiver attribute information in the order system may include multiple pieces of information, which, can be, for example, presentation information of a product having a similar shape to a product purchased by the order receiver, presentation information of a product having a similar price to the product purchased by the receiver, presentation information of a product having a similar color to the product purchased by the receiver, presentation information of a product having a similar function to the product purchased by the receiver, and the like. The foregoing listed several types of information may be used as candidate information for priority ranking in the following step:

ranking the multiple pieces of candidate information in a preset priority ranking manner.

Using the example in the previous step, the candidate information is respectively presentation information of a product having a similar shape to a product purchased by the order receiver, presentation information of a product having a similar price to the product purchased by the receiver, presentation information of a product having a similar color to the product purchased by the receiver, and presentation information of a product having a similar function to the product purchased by the receiver. The candidate information is ranked according to preset priorities, where, in some embodiments, a priority order may be set to price, function, shape, or color. Therefore, the foregoing candidate information may be ranked according to the priority order. Candidate information ranking high may be used as presentation information.

Correspondingly, after ranking is performed according to the priority order, for example, of price, function, shape, and color, candidate information of a product having a similar price to the product purchased by the receiver will rank high. This candidate information may be used as presentation information.

In some embodiments, for each type of attribute information, corresponding presentation information may be separately filtered out in the preset information system, specifically in the following manner:

The filtering out, in a preset information system according to attribute information, presentation information corresponding to the corresponding attribute information includes:

determining whether presentation information corresponding to the attribute information exists in the preset information system; and if yes, ranking corresponding presentation information in a preset manner; and

obtaining information ranking high in the presentation information as the presentation information to be displayed on the electronic waybill.

The method of obtaining corresponding presentation information according to attribute information is further described below by using a specific example.

The presentation information may include channel presentation information, which may include a combination of order and channel presentation information. The channel presentation information corresponds to the order source information in the order information.

It is determined whether corresponding channel presentation information corresponding to an order channel exists in the preset information system, and if yes, a relatively optimum piece of information is selected according to determining results and used as filtered out channel presentation information in the presentation information.

For example, if the order source information in the order information is information of a merchant on Taobao™, presentation information related to Taobao™ may be filtered out in the preset information system according to the order source information (Taobao™). For example, the presentation information may be that Taobao™ will provide special offers on a particular day. Therefore, the information related to Taobao™ may be used as presentation information for presentation on a corresponding electronic waybill.

The presentation information may include provider presentation information, including provider-related presentation information that can be presented.

It is determined whether corresponding provider presentation information corresponding to the order provider exists in the preset information system, and if yes, a relatively optimum piece of information is selected according to determining results and used as filtered out provider presentation information in presentation information.

For example, the provider attribute information may be information of a shop of the provider that is a merchant. A large amount of information related to the shop of the merchant and related products of the merchant is stored in the preset information system. A primarily promoted product in the shop of the merchant may be filtered out in the preset information system according to the information of the shop of the merchant, and specific information of the product may be used as presentation information corresponding to the information of the shop.

The presentation information may include receiver presentation information, which may include receiver-related presentation information that can be presented.

It is determined whether corresponding receiver presentation information corresponding to the order receiver exists in the preset information system, and if yes, a relatively optimum piece of information is selected according to determining results and used as filtered out receiver presentation information in presentation information.

In addition, the ranking manner in the ranking corresponding presentation information in a preset manner is a preset priority ranking manner. Alternatively, the ranking manner in the ranking corresponding presentation information in a preset manner is a preset stochastic ranking manner. In some embodiments, the ranking manner in the ranking corresponding presentation information in a preset manner may be a preset weight selection manner. In some other embodiments, the ranking manner in the ranking corresponding presentation information in a preset manner may be a preset time-based selection manner. The time-based selection manner in the ranking in the preset time-based selection manner may be a season-based selection manner. For example, warm-keeping products may be mainly promoted in winter. Therefore, in priority ranking, information related to winter can be used as primary reference criteria.

The presentation information may include product category presentation information, which includes presented information on products of corresponding categories or of similar categories after products are categorized according to types and categories of the products.

Based on product category information, it is determined whether corresponding product category presentation information or related category information exists in the preset information system, or whether presentation information of a corresponding attribute of a product in industrial upstream or downstream exists in the preset information system, and if yes, a relatively optimum piece of information is selected according to determining results and used as product category presentation information in presentation information.

The presentation information may include industrial chain presentation information, which includes presentation information corresponding to upstream or downstream of an industrial chain.

The presentation information may include receiver location presentation information, which includes an address of a location in which the receiver is located and information on a geographical region corresponding to the address.

It is determined whether corresponding receiver location presentation information corresponding to the order receiver location exists in the preset information system, and if yes, a relatively optimum piece of information is selected according to determining results and used as filtered out receiver location presentation information in presentation information.

Presentation information is obtained by the order platform according to the foregoing description. Before the presentation information is printed on the electric waybill, the presentation information may be referred to as candidate presentation information. In the preset information system, which piece of information is finally used as presentation information on the electric waybill is determined according to a platform strategy.

In an actual situation, the platform strategy is generally a priority strategy, where, in some embodiments, priorities may be respectively channel presentation information, receiver presentation information, product category presentation information, industrial chain upstream and downstream presentation information, receiver attribute presentation information, receiver address and location presentation information, and so on.

In some embodiments, based on different situations, relatively optimum presentation information may also not be selected for presentation in this step. Instead, priority ranking is performed, and one or more pieces of information ranking the highest (which may be determined according to a size of a waybill) is selected.

A person having ordinary skill in the art should appreciate that any ranking manner listed above falls within the protection scope of the present application, and other manners similar to the listed ranking manners can also be used and fall within the protection scope of the present application.

The receiver-related presentation information that can be presented may include one or more pieces of the following information: information on selection or browsing of products by the receiver, information on browsing on a related platform by the receiver, or information on basic information of the receiver.

Specifically, information such as purchase habits and lately browsed goods of the receiver is obtained according to receiver information. Information such as a current life stage, an economic strength, and a social circle of the receiver is determined according to traces of the receiver in social networks and other Internet platforms. It is determined, according to the foregoing information, whether corresponding presentation information exists in the preset information system, and if yes, a relatively optimum piece of information is selected according to determining results and used as receiver presentation information.

In the above description, both the foregoing mentioned receiver and provider are described in respective of the order receiver and the order provider.

S103: Display the presentation information on an electronic waybill.

This step is a process of displaying the foregoing formed presentation information on an electronic waybill. A form or format of the presentation information displayed on the electronic waybill, or a manner of displaying the presentation information on the electronic waybill will be described in detail below.

In some embodiments, before or after step S101, a process of obtaining a waybill number is further provided, and a waybill number can be obtained by using this process. Thus, generally, objects displayed on the electronic waybill may be a combination of a waybill number and the presentation information.

FIG. 2 is a schematic diagram of objects displayed on an electronic waybill in the first embodiment of the present application. As shown in FIG. 2, information that may be displayed on the electronic waybill may include a waybill number 201 and the presentation information 202 that is obtained in step 102. In some embodiments, the waybill number 201 and the presentation information 202 are separately displayed on the electronic waybill as two parts.

The waybill number 201 may be considered to be an express number on a common express waybill that represents a unique identification number of an express package. The waybill number 201 is a unique identifier of the electronic waybill. The waybill number 201 is generally formed by combining digits and characters into a string, or a bar code or a two-dimensional code for displaying on the electronic waybill.

In addition, the presentation information 202 is the information logically related to content of the characteristic information of the order receiver or the order provider that is obtained in the foregoing step.

Specifically, the presentation information 202 may be information related to the order receiver, or may be information related to the order provider. For example, the presentation information 202 may be information of a shop of a merchant that is the provider, or may be promotion information of a related product of a product purchased by the receiver. The presentation information is presented on an electronic waybill, and finally reaches the receiver along with a parcel or package. Therefore, the presentation information 202 offers a user an opportunity for providing additional information, and the user conveniently obtains more information according to the presentation information 202 on the electronic waybill, achieving effects of information promotion.

In addition, the presentation information 202 may be one piece of information, or may be formed by combining multiple pieces of information. The presentation information 202 in FIG. 2 is only a schematic illustration. Alternatively, a fixed area, for example, an area for the presentation information 202 in FIG. 2, on the electronic waybill, may be set to be a display area for presentation information, and the presentation information obtained in the foregoing step may be displayed in the display area.

The presentation information may be displayed on the electronic waybill in a preset information display manner. The preset information display manner is a preset display manner of one or more types of information, and the display manner changes with development of applications of computers. A currently common display manner may include one or more of the following manners: a two-dimensional code display manner, an icon display manner, an indicative picture display manner, or a bar code display manner.

The two-dimensional code manner is widely used for information collection and communication. Existing electronic devices can obtain, through scanning, information included in a two-dimensional code in a short time by using an image recognition system. A user may scan the two-dimensional code, and reads information of the two-dimensional code by using corresponding scanning software. By means of the two-dimensional code manner, on one hand, a speed of information reading can be ensured, and on the other hand, information corresponding to the two-dimensional code can be encrypted to some extent, and the user can read corresponding information only by scanning the two-dimensional code, otherwise, the user cannot view specific information presented by the two-dimensional code.

Displaying presentation information in the icon manner can make it convenient for recognition and understanding of a user. For example, if presentation information is an icon for a LOGO of a product, the icon for the LOGO may be directly used as presentation information for presentation on the electronic waybill.

The indicative picture display manner means that some indicative pictures may be used as a part of presentation information for presentation on the electronic waybill.

A person having ordinary skill in the art should appreciate that the information display manner is not limited to the several display manners listed above, and any display manner that can be used to display information on some platforms falls within the protection scope of the present application.

The waybill number is generally displayed by using Arabic numerals, or the waybill number may also be converted into a form of a two-dimensional code or a bar code for displaying on the electronic waybill. A person having ordinary skill in the art should appreciate that other displaying manners for displaying the waybill number on the electronic waybill may also be used.

In addition, the generated presentation information and waybill number on the electronic waybill may be sent to an e-commerce order system, and the e-commerce order system may form a complete electronic waybill according to the foregoing information, and then a printing system can be called by using the e-commerce order system for printing the electronic waybill.

Specifically, after the step of forming electronic waybill information by using the waybill number and the presentation information for presentation on the electronic waybill, the method may further include: displaying the presentation information and the waybill number on the electronic waybill in an electronic waybill printing manner.

The electronic waybill printing manner includes printing the electronic waybill by using a preset printing component.

The e-commerce order system may call a standard printing component to print the electronic waybill. In this case, information included in the electronic waybill may include the waybill number and presentation information related to provider information or receiver information in the attribute information of the order information. A printed electronic waybill is attached to a package and delivered to the receiver along with the package.

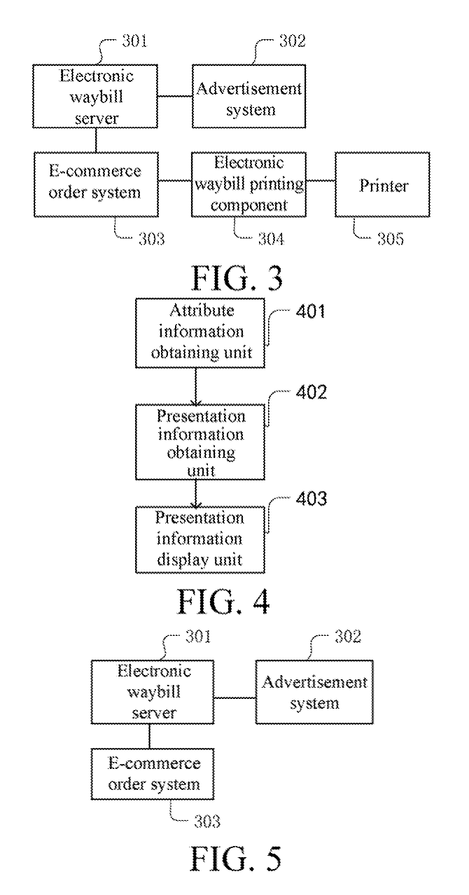

FIG. 3 is a system diagram of an application scenario of the information presentation method based on electronic waybill according to the first embodiment of the present application. Referring to FIG. 3, a specific application of the method is as follows:

An e-commerce order system 303 uploads an order number (order information) to an electronic waybill server 301, so as to obtain a waybill number (express waybill number) corresponding to the order number. The electronic waybill server 301 obtains attribute information, for example, order source information, purchaser information (receiver attribute information), or delivery address (receiver address information), of the order information on the order platform according to the received order number. The electronic waybill server 301 determines, according to the attribute information of the order, whether an advertisement corresponding to a piece of attribute information exists in an advertisement system (a preset information system) 302, and if yes, the advertisement system determines an order according to priorities, and filters out a desired advertisement according to the order of priorities. The filtered-out advertisement and an obtained waybill number are sent to the e-commerce order system 303 through the electronic waybill server 301, the e-commerce order system calls an electronic waybill printing component 304, and the electronic waybill printing component controls and starts a printer 305 to print the electronic waybill. The electronic waybill includes the waybill number and presentation information, for example, the advertisement, and the electronic waybill is delivered to the order receiver along with a package.

In summary, according to the method, by using an electronic waybill, which is a combination of online and offline, electronic waybill paper attached on a package not only includes a waybill number, but also includes presentation information related to order information and to at least one of a provider or a receiver. Therefore, the presentation information can help promote and communicate additional information via the waybill. Moreover, the presentation information is accurately obtained from a related online system. Therefore, an accurate offline information pushing capability can be achieved.

A second embodiment of the present application provides an information presentation apparatus based on an electronic waybill. FIG. 4 is a schematic structural diagram of the information presentation apparatus based on an electronic waybill provided in the second embodiment of the present application. Referring to FIG. 4, the information presentation apparatus includes:

an attribute information obtaining unit 401, configured to obtain attribute information of order information according to the order information;

a presentation information obtaining unit 402, configured to filter out, in a preset information system based on characteristic information of at least one of an order receiver or an order provider in the attribute information, presentation information corresponding to the order receiver or the order provider, where the presentation information is information logically related to content of the attribute information; and

a presentation information display unit 403, configured to display the presentation information on an electronic waybill.

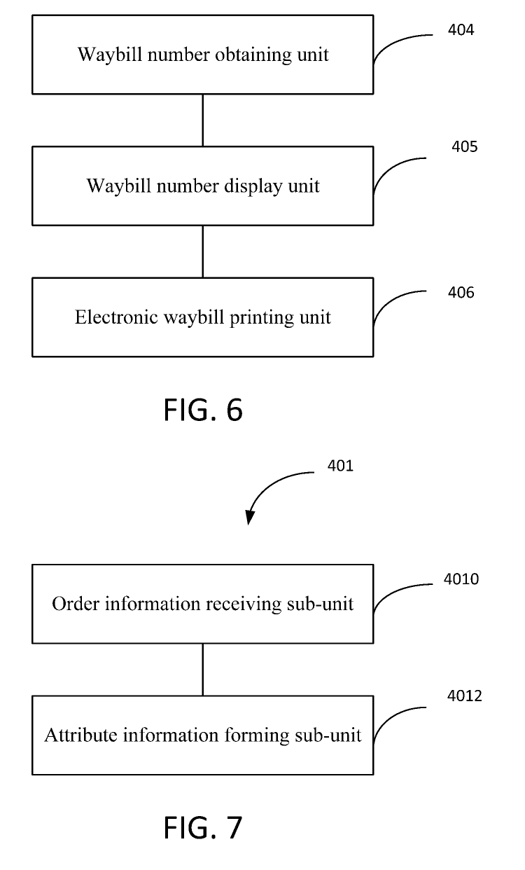

In some embodiments, as shown in FIG. 6, the apparatus may further include:

a waybill number obtaining unit 404, configured to obtain a waybill number of the order information according to the order information before or after the step of obtaining attribute information of order information according to the order information; and

a waybill number display unit 405, configured to display the waybill number on the electronic waybill.

In some other embodiments, as shown in FIG. 6, the apparatus may further include: an electronic waybill printing unit 406, configured to display the presentation information and the waybill number on the electronic waybill in an electronic waybill printing manner.

As shown in FIG. 7, the attribute information obtaining unit 401 may include:

an order information receiving sub-unit 4010, configured to receive order information sent by an order system; and

an attribute information forming sub-unit 4012, configured to obtain attribute information from an order platform according to the order information.

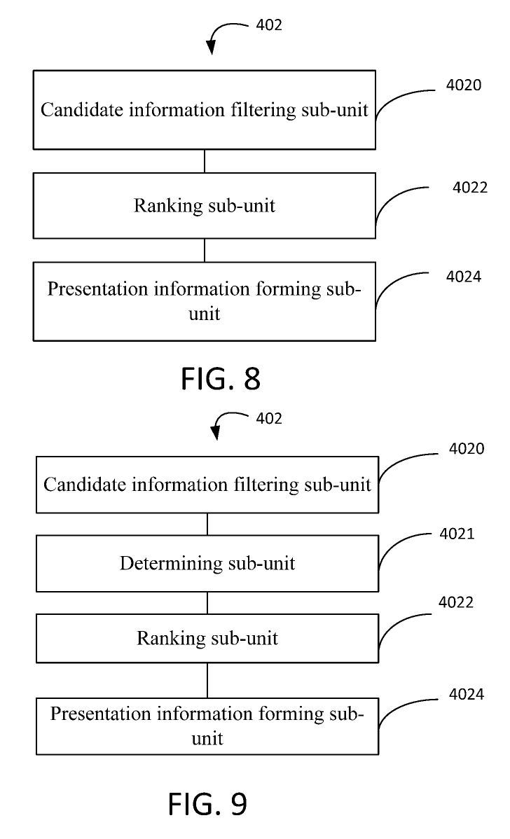

As shown in FIG. 8, the presentation information obtaining unit may include:

a candidate information filtering sub-unit 4020, configured to filter out, in the preset information system, multiple pieces of candidate information corresponding to the attribute information;

a ranking sub-unit 4022, configured to rank the multiple pieces of candidate information in a preset priority ranking manner; and

a presentation information forming sub-unit 4024, configured to use candidate information ranking high as the presentation information.

As shown in FIG. 9, the presentation information obtaining unit 402 may further include:

a determining sub-unit 4021, configured to: determine whether there are candidate information corresponding to at least one of the order receiver or the order provider in the attribute information exists in the preset information system; and if yes, rank the candidate information in a preset manner; and

the presentation information forming sub-unit 4024, configured to obtain information ranking high in the candidate information as the presentation information.

The electronic waybill information forming unit may include a presentation information presentation sub-unit, configured to display the presentation information on the electronic waybill in a preset information display manner.

The embodiment of the information presentation apparatus based on an electronic waybill provided in the second embodiment of the present application corresponds to the embodiment of the information presentation method based on an electronic waybill provided in the first embodiment of the present application. Therefore, the apparatus provided in the second embodiment of the present application is not described in detail. For specific details, refer to the description of the information presentation method based on an electronic waybill provided in the first embodiment of the present application.

A third embodiment of the present application further provides an information presentation system based on an electronic waybill. Referring to FIG. 5, the system includes an electronic waybill server 301, an advertisement system 302, and an e-commerce order system 303. These components can be the same as or similar to the components in FIG. 3 and described above, and thus, same reference numbers are used. The e-commerce order system is used to provide order information for the electronic waybill server. The electronic waybill server obtains attribute information of order information according to the order information provided by the e-commerce order system. The electronic waybill server filters out, in the advertisement system based on characteristic information of at least one of an order receiver or an order provider in the attribute information, presentation information corresponding to the order receiver or the order provider. The electronic waybill server outputs the presentation information to the e-commerce order system, and displays the presentation information on an electronic waybill in the e-commerce order system. The presentation information is information logically related to content of the attribute information.

In some embodiments, the system may further include an electronic waybill printing component and a printer, where the presentation information is displayed on the electronic waybill by using the electronic waybill printing component and the printer. An e-commerce order system 303 uploads an order number (order information) to an electronic waybill server 301, so as obtain a waybill number (express waybill number) corresponding to the order number. The electronic waybill server obtains attribute information, for example, order source information, purchaser information (receiver attribute information), or delivery address (receiver address information), of the order information on the order platform according to the received order number. The electronic waybill server 301 determines, according to the attribute information of the order, whether an advertisement corresponding to a piece of attribute information exists in an advertisement system (a preset information system) 302, and if yes, the advertisement system determines an order according to priorities, and screens out a desired advertisement according to the order of priorities. For a specific filtering process, refer to the descriptions in the foregoing steps. The filtered-out advertisement and an obtained waybill number are sent to the e-commerce order system 303 through the electronic waybill server 301, the e-commerce order system calls an electronic waybill printing component 304 (see FIG. 3), and the electronic waybill printing component controls and starts a printer 305 (see FIG. 3) to print the electronic waybill. The electronic waybill includes the waybill number and presentation information, for example, the advertisement, and the electronic waybill is delivered to a receiver along with a package.

Another aspect of the disclosure is directed to a non-transitory computer-readable storage medium storing instructions which, when executed, cause one or more processors to perform methods, as discussed above. The computer-readable storage medium may include volatile or non-volatile, magnetic, semiconductor, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for presenting information. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for displaying information on an electronic waybill, comprising:
obtaining attribute information of order information according to the order information;
based on characteristic information of at least one of an order receiver or an order provider in the attribute information, filtering out, in a preset information system, presentation information corresponding to at least one of the order receiver or the order provider, wherein the presentation information is related to the attribute information; and
displaying the presentation information on an electronic waybill.

2. The method for displaying information on an electronic waybill according to claim 1, further comprising:
obtaining a waybill number of the order information according to the order information; and
displaying the waybill number on the electronic waybill.

3. The method for displaying information on an electronic waybill according to claim 1, wherein the filtering out, in a preset information system, presentation information corresponding to the order receiver or the order provider comprises:
filtering out, in the preset information system, two or more pieces of candidate information corresponding to the attribute information;
ranking the two or more pieces of candidate information in a preset priority ranking manner; and
using candidate information ranking high as the presentation information.

4. The method for displaying information on an electronic waybill according to claim 1, wherein the attribute information comprises one or more pieces of the following information: order source information, provider attribute information, receiver attribute information, product category information, receiver address information, or provider address information.

5. The method for displaying information on an electronic waybill according to claim 1, wherein the obtaining attribute information of order information according to the order information comprises:
receiving the order information from an order system; and
obtaining the attribute information from an order platform according to the order information.

6. The method for displaying information on an electronic waybill according to claim 1, wherein the presentation information comprises a combination of one or more pieces of the following information: channel presentation information, provider presentation information, receiver presentation information, product category presentation information, industrial chain presentation information, or receiver location presentation information.

7. The method for displaying information on an electronic waybill according to claim 6, wherein the filtering out, in a preset information system, presentation information corresponding to the order receiver or the order provider comprises:
determining whether there are candidate information corresponding to at least one of the order receiver or the order provider in the attribute information exists in the preset information system; and
if yes, ranking the candidate information in a preset manner; and
obtaining information ranking high in the candidate information as the presentation information.

8. The method for displaying information on an electronic waybill according to claim 7, wherein the preset manner comprises one or more of the following manners: a preset priority ranking manner, a preset stochastic ranking manner, a preset weight selection manner, or a preset time-based selection manner.

9. The method for displaying information on an electronic waybill according to claim 8, wherein the preset manner is the preset time-based selection manner, and the time-based selection manner is a season-based selection manner.

10. The method for displaying information on an electronic waybill according to claim 6, wherein the presentation information is the channel presentation information, and the channel presentation information comprises order and channel presentation information.

11. The method for displaying information on an electronic waybill according to claim 6, wherein the presentation information is the provider presentation information, which includes provider-related information.

12. The method for displaying information on an electronic waybill according to claim 6, wherein the presentation information is the receiver presentation information, which includes receiver-related information.

13. The method for displaying information on an electronic waybill according to claim 12, wherein the receiver presentation information comprises one or more pieces of the following information: information on selection or browsing of products by the receiver, information on browsing on a related platform by the receiver, or information on basic information of the receiver.

14. The method for displaying information on an electronic waybill according to claim 6, the presentation information is the product category presentation information, and the product category presentation information comprises information on products of corresponding categories or of similar categories.

15. The method for displaying information on an electronic waybill according to claim 6, wherein the presentation information is the industrial chain presentation information, and the industrial chain presentation information comprises presentation information corresponding to an upstream or downstream of an industrial chain.

16. The method for displaying information on an electronic waybill according to claim 6, wherein the presentation information is the receiver location presentation information, and the receiver location presentation information comprises an address of a location in which the receiver is located and information on a geographical region corresponding to the address.

17. The information presentation method based on an electronic waybill according to claim 1, wherein the displaying the presentation information on an electronic waybill comprises:
displaying the presentation information on the electronic waybill in one or more of the following manners: a two-dimensional code display manner, an icon display manner, an indicative picture display manner, or a bar code display manner.

18. An apparatus for displaying information on an electronic waybill, comprising:
an attribute information obtaining unit, configured to obtain attribute information of order information according to the order information;
a presentation information obtaining unit, configured to filter out, in a preset information system, based on characteristic information of at least one of an order receiver or an order provider in the attribute information, presentation information corresponding to at least one of the order receiver or the order provider, wherein the presentation information is related to the attribute information; and
a presentation information display unit, configured to display the presentation information on an electronic waybill.

19. The apparatus for displaying information on an electronic waybill according to claim 18, further comprising:
a waybill number obtaining unit, configured to obtain a waybill number of the order information according to the order information; and
a waybill number displaying unit, configured to display the waybill number on the electronic waybill.

20. An information presentation system, comprising an electronic waybill server, an advertisement system, and an e-commerce order system, wherein
the e-commerce order system provides order information for the electronic waybill server;
the electronic waybill server obtains attribute information of order information according to the order information provided by the e-commerce order system;
the electronic waybill server filters out, in the advertisement system based on characteristic information of at least one of an order receiver or an order provider in the attribute information, presentation information corresponding to at least one of the order receiver or the order provider; and
the electronic waybill server outputs the presentation information to the e-commerce order system for displaying the presentation information on an electronic waybill in the e-commerce order system, wherein the presentation information is related to the attribute information.
